(19) United States
(12) Patent Application Publication
(10) Pub. No.: US 2020/0379414 A1
(43) Pub. Date: Dec. 3, 2020

(54) ELECTRONIC WATCH WITH INTERNAL ANTENNA

(71) Applicant: Seiko Epson Corporation, Tokyo (JP)

(72) Inventor: Hironobu YAMAMOTO, Shiojiri (JP)

(21) Appl. No.: 16/884,131

(22) Filed: May 27, 2020

(30) Foreign Application Priority Data
May 28, 2019 (JP) 2019-099333

(51) Int. Cl. G04R 60/12; G04C 3/00; G04G 21/04

(52) U.S. Cl. CPC G04R 60/12; G04G 21/04; G04C 3/008

(57) ABSTRACT

An electronic watch includes: an outer case; a dial; a first pointer that includes a first conductive portion, and is disposed between the dial and a cover member; a second pointer that includes a second conductive portion, and is disposed farther away from the dial than the first pointer is; an antenna including a first conductor element disposed between the dial and a case back, a second conductor element that is disposed farther away from the dial than the first conductor element is and overlaps the first conductor element, and a short-circuit element that short-circuits the first conductor element and the second conductor element; and a drive unit that moves the first pointer or the second pointer such that the first conductive portion and the second conductive portion overlap each other for a part of a period of reception processing in which the antenna is used.

The present application is based on, and claims priority from, JP Application Serial Number 2019-099333, filed May 28, 2019, the disclosure of which is hereby incorporated by reference herein in its entirety.

### BACKGROUND

### 1. Technical Field

The present disclosure relates to electronic watch with internal antenna.

### 2. Related Art

JP-A-2018-136296 discloses an electronic watch in which a planer inverted-F antenna including a planer first conductor element, a planer second conductor element, and a short-circuit element that short-circuits each of the conductor elements is disposed on a back surface side of a dial in a case of the watch.

In the watch in JP-A-2018-136296, a pointer overlaps the conductor element in plan view, and thus, when the pointer includes a conductive portion formed of a conductive material such as metal, there is a problem in that a parasitic capacitor is generated between the conductive portion of the pointer and the conductor element and reception sensitivity decreases.

### SUMMARY

An electronic watch with internal antenna of the present disclosure includes an outer case including a case body, a case back, and a cover member, a dial disposed between the cover member and the case back in the outer case, a first pointer including a first conductive portion formed of a conductive material, the first pointer being disposed between the dial and the cover member, a second pointer including a second conductive portion formed of a conductive material, the second pointer being disposed farther away from the dial than the first pointer is and between the dial and the cover member, an antenna including a first conductor element disposed between the dial and the case back, a second conductor element disposed farther away from the dial than the first conductor element is and between the dial and the case back and overlapping the first conductor element in plan view when seen along an axial direction orthogonal to a front surface, which faces the cover member, of the dial, and a short-circuit element short-circuiting the first conductor element and the second conductor element, and a drive unit moving the first pointer or the second pointer such that the first conductive portion and the second conductive portion overlap each other in the plan view for a part of a period of reception processing in which the antenna is used.

In the electronic watch with internal antenna of the present disclosure, the drive unit may move the first pointer or the second pointer to a position in which 60% or more of a planar area of the second conductive portion overlaps the first conductive portion in the plan view.

The electronic watch with internal antenna of the present disclosure may further include a third pointer that includes a third conductive portion formed of a conductive material, and is disposed farther away from the dial than the second pointer is and between the dial and the cover member, and a second drive unit that moves the third pointer such that the third conductive portion overlaps the first conductive portion or the second conductive portion in the plan view for a part of a period of reception processing using the antenna.

In the electronic watch with internal antenna of the present disclosure, the second drive unit may move the third pointer to a position in which 60% or more of a planar area of the third conductive portion overlaps the first conductive portion or the second conductive portion in the plan view.

In the electronic watch with internal antenna of the present disclosure, the reception processing may be processing of receiving a satellite signal transmitted from a positional information satellite using the antenna, and acquiring time information included in the satellite signal.

In the electronic watch with internal antenna of the present disclosure, the reception processing may be processing of receiving a satellite signal transmitted from three or more positional information satellites using the antenna, and calculating positional information using the satellite signal.

In the electronic watch with internal antenna of the present disclosure, a total value of planar areas of the conductive portions of the pointers provided in a position overlapping the first conductor element in the plan view may be less than 50 mm².

In the electronic watch with internal antenna of the present disclosure, a distance between the first pointer and the first conductor element in an axial direction orthogonal to a front surface of the dial may be equal to or greater than 1.35 mm.

In the electronic watch with internal antenna of the present disclosure, a pointer shaft to which the first pointer is attached and a pointer shaft to which the second pointer is attached may be formed of a conductive material.

In the electronic watch with internal antenna of the present disclosure, a pointer shaft to which the first pointer is attached, a pointer shaft to which the second pointer is attached, and a pointer shaft to which the third pointer is attached may be formed of a conductive material.

### BRIEF DESCRIPTION OF THE DRAWINGS

FIG. 1 is a front view illustrating a main portion of an electronic watch according to a first exemplary embodiment.

FIG. 2 is a cross-sectional view illustrating the main portion of the electronic watch described above.

FIG. 3 is a block diagram illustrating a configuration of a drive unit that drives a pointer of the electronic watch described above.

FIG. 4 is a perspective view illustrating a planer inverted-F antenna used in the electronic watch described above.

FIG. 5 is a plan view illustrating the planer inverted-F antenna described above.

FIG. 6 is a flowchart illustrating pointer drive control during timekeeping reception processing of the electronic watch described above.

FIG. 7 is a flowchart illustrating pointer drive control during positioning reception processing of the electronic watch described above.

FIG. 8 is a diagram illustrating a movement of the pointer during the positioning reception processing of the electronic watch described above.

FIG. 9 is a front view illustrating a main portion of an electronic watch according to a second exemplary embodiment.

FIG. 10 is a cross-sectional view illustrating the main portion of the electronic watch according to the second exemplary embodiment.

FIG. 11 is a front view illustrating a main portion of an electronic watch according to a third exemplary embodiment.

FIG. 12 is a front view illustrating a main portion of an electronic watch according to a fourth exemplary embodiment.

FIG. 13 is a front view illustrating a main portion of an electronic watch according to a fifth exemplary embodiment.

FIG. 14 is a cross-sectional view illustrating a main portion of an electronic watch according to a modified example.

FIG. 15 is a flowchart illustrating pointer drive control during timekeeping reception processing of an electronic watch according to a modified example.

### DESCRIPTION OF EXEMPLARY EMBODIMENTS

### First Exemplary Embodiment

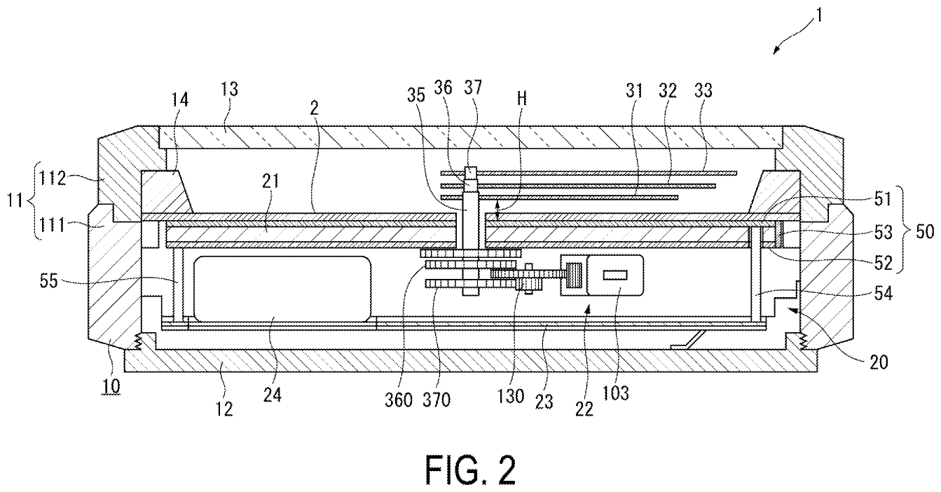

An electronic watch with internal antenna 1 according to a first exemplary embodiment of the present disclosure will be described below with reference to the drawings. Note that, in the following description, the electronic watch with internal antenna will be described simply as an electronic watch. Further, the present exemplary embodiment will be described with a cover member 13 side of the electronic watch 1 illustrated in FIG. 2 as a front surface side or an upper side and with a case back 12 side as a rear surface side or a lower side.

As described below, the electronic watch 1 in the present exemplary embodiment includes a planer inverted-F antenna 50, and is configured so as to be able to receive a satellite signal from a positional information satellite such as a plurality of GPS satellites and quasi-zenith satellites that circle in a predetermined orbit in the sky of the Earth, acquire satellite time information, and correct internal time information.

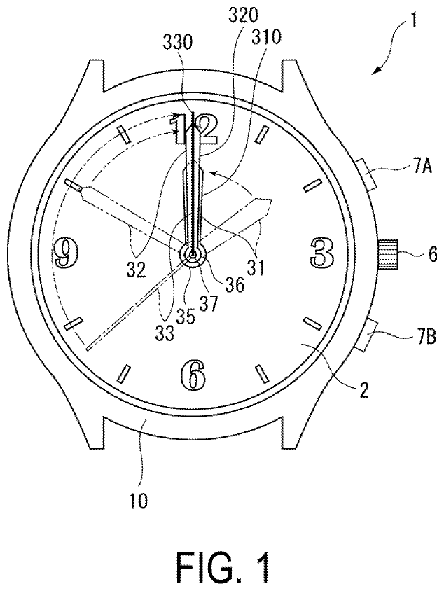

As illustrated in FIGS. 1 and 2, the electronic watch 1 includes an outer case 10 that houses a dial 2, a movement 20, an hour hand 31, a minute hand 32, a seconds hand 33, the planer inverted-F antenna 50, a battery 24, and the like. Further, the electronic watch 1 includes a crown 6 for an external operation and two buttons 7A and 7B. The movement 20 includes pointer shafts 35, 36, and 37 to which the hour hand 31, the minute hand 32, and the seconds hand 33 are attached. The pointer shafts 35 to 37 are formed of a conductive material such as metal. Note that FIG. 2 is a cross-sectional view taken along a line connecting a 6 o'clock position and a 12 o'clock position of the dial 2.

The dial 2 is formed in a disc shape by a non-conductive member such as polycarbonate. The three pointer shafts 35, 36, and 37 provided coaxially are disposed at the planar center of the dial 2. The pointer shaft 35 is an hour wheel, and the hour hand 31 is attached thereto. The pointer shaft 36 is formed of a center wheel and pinion 360 and a cannon pinion attached to the center wheel and pinion 360, and the minute hand 32 is attached thereto. The pointer shaft 37 is formed of a fourth wheel and pinion 370 and a shaft of the fourth wheel and pinion 370, and the seconds hand 33 is attached thereto. The pointer shafts 35, 36, and 37 are formed of a conductive material. Note that, in the present exemplary embodiment, a date window and a date indicator are not provided, but they may be provided.

The hour hand 31, the minute hand 32, and the seconds hand 33 are driven via a step motor and a train wheel that are described below. Further, the hour hand 31, the minute hand 32, and the seconds hand 33 are entirely formed of a metal conductive material. Here, in the present exemplary embodiment, a first pointer is constituted by the hour hand 31, a second pointer is constituted by the minute hand 32, and a third pointer is constituted by the seconds hand 33. Thus, in the following description, the hour hand 31, the minute hand 32, and the seconds hand 33 may be referred to as pointers 31, 32, and 33.

Since the hour hand 31, the minute hand 32, and the seconds hand 33 are each entirely formed of a metal conductive material, a first conductive portion 310 of the hour hand 31 being the first pointer is formed of the entire hour hand 31, a second conductive portion 320 of the minute hand 32 being the second pointer is formed of the entire minute hand 32, and a third conductive portion 330 of the seconds hand 33 being the third pointer is formed of the entire seconds hand 33.

In the present exemplary embodiment, a planar area of the hour hand 31, namely, the first conductive portion 310 is 13 mm², a planar area of the minute hand 32, namely, the second conductive portion 320 is 12 mm², and a planar area of the seconds hand 33, namely, the third conductive portion 330 is 4 mm². Therefore, a total value of the planar areas of the first conductive portion 310, the second conductive portion 320, and the third conductive portion 330 provided in positions overlapping a first conductor element 51 of the planer inverted-F antenna 50 described below in plan view is 13+12+4=29 mm² and is less than 50 mm².

Note that, in the present exemplary embodiment, a plan view means that the dial 2 and the like are viewed from an axial direction orthogonal to the front surface facing the cover member 13 of the dial 2, that is, from an axial direction of the pointer shafts 35 to 37.

As illustrated in FIG. 2, the outer case 10 includes a case main body 11, the case back 12, and the cover member 13. The case main body 11 includes a cylindrical case body 111 and a bezel 112 provided on a front surface side of the case body 111. Note that, in the present exemplary embodiment, the case body 111 and the case back 12 are formed separately, which is not limited thereto. A one-piece case in which the case body 111 and the case back 12 are integrated may be used.

The case body 111, the bezel 112, and the case back 12 are manufactured of a metal material, such as stainless steel, a titanium alloy, aluminum, and brass, or a synthetic resin material. The cover member 13 is manufactured of glass, a synthetic resin material, or the like.

Next, an internal structure included in the outer case 10 of the electronic watch 1 will be described.

As illustrated in FIG. 2, in addition to the dial 2, the movement 20, the planer inverted-F antenna 50, a dial ring 14, and the like are housed in the outer case 10.

The movement 20 includes a main plate 21, a train wheel bridge (not illustrated), a drive mechanism 22 supported by the main plate 21 and the train wheel bridge, a printed circuit board 23, and the battery 24. The main plate 21 is formed of a non-conductive member such as plastic.

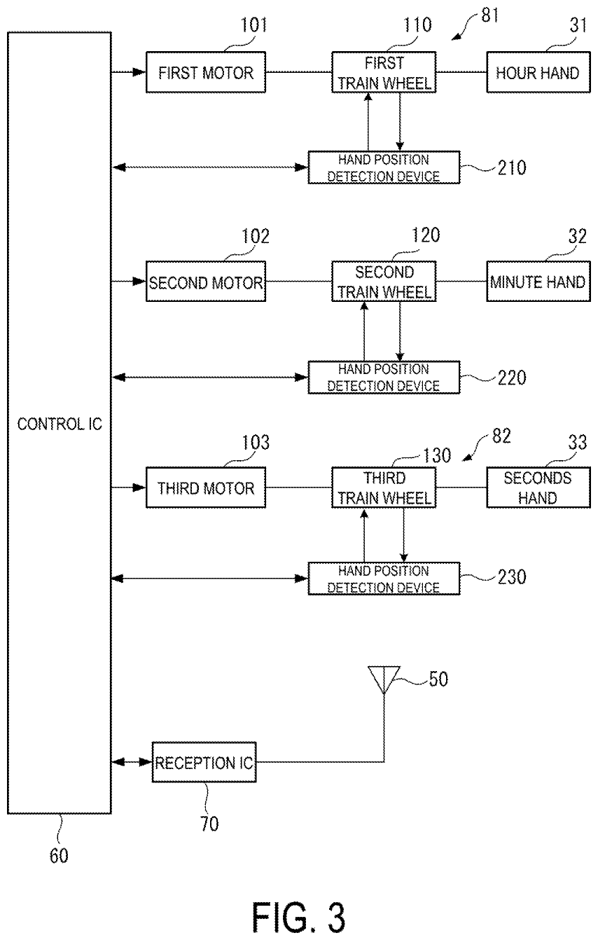

As illustrated in FIGS. 2 and 3, the drive mechanism 22 is disposed between the main plate 21 and the train wheel bridge, and includes a first motor 101 and a first train wheel 110 that drive the hour hand 31, a second motor 102 and a second train wheel 120 that drive the minute hand 32, and a third motor 103 and a third train wheel 130 that drive the seconds hand 33. Note that, in FIG. 2, only the third motor 103 and the third train wheel 130 are illustrated, and the first motor 101, the second motor 102, the first train wheel 110, and the second train wheel 120 are omitted.

Furthermore, hand position detection devices 210, 220, and 230 that detect a hand position of the hour hand 31, the minute hand 32, and the seconds hand 33 are provided in the movement 20. For the hand position detection devices 210, 220, and 230, for example, a general hand position detection device including a light emitting element, a light receiving element, and a gear having a hole for position detection provided in each of the first train wheel 110, the second train wheel 120, and the third train wheel 130 can be used.

Although not illustrated in FIG. 2, a control IC 60, a reception IC 70, and the like are mounted on the printed circuit board 23. The control IC 60 performs time display processing of controlling drive of the first motor 101, the second motor 102, and the third motor 103, moving the hour hand 31, the minute hand 32, and the seconds hand 33, and displaying time under normal circumstances. Further, the control IC 60 performs hand position detection processing of activating the hand position detection devices 210, 220, and 230 at a predetermined timing, such as 00:00:00, and checking whether or not the hour hand 31, the minute hand 32, and the seconds hand 33 are located in a predetermined position, for example, a position indicating 00:00:00.

Furthermore, when receiving a satellite signal, the control IC 60 activates the reception IC 70 and performs reception processing by the planer inverted-F antenna 50, and also performs reception movement processing of activating the first motor 101, the second motor 102, and the third motor 103, moving the hour hand 31, the minute hand 32, and the seconds hand 33 to a reception standby position, and stopping them in the reception standby position.

Thus, a drive unit 81 that moves the hour hand 31 or the minute hand 32 such that the first conductive portion 310 and the second conductive portion 320 overlap each other in the plan view in a part of a period of the reception processing using the planer inverted-F antenna 50 includes the control IC 60, the first motor 101, the first train wheel 110, the second motor 102, and the second train wheel 120.

Further, a second drive unit 82 that moves the seconds hand 33 such that the third conductive portion 330 overlaps the first conductive portion 310 or the second conductive portion 320 in the plan view in a part of a period of the reception processing using the planer inverted-F antenna 50 includes the control IC 60, the third motor 103, and the third train wheel 130.

The battery 24 may be a primary battery or a secondary battery. When a secondary battery is provided, a power generation device for charging the secondary battery may be incorporated into the electronic watch 1. For example, when a solar panel is provided as the power generation device, the solar panel may be disposed between the dial 2 and the first conductor element 51 of the planer inverted-F antenna 50 described below, and the dial 2 may be formed of a light-transmissive member. Note that, when a solar panel is provided, a planar size of the solar panel may be smaller than that of the first conductor element 51, and at least a part of the first conductor element 51 may be disposed outside an outer edge of the solar panel in the plan view. Such a configuration can reduce an influence of the solar panel on the reception processing of a satellite signal in the planer inverted-F antenna 50 and can improve reception sensitivity.

Planer Inverted-F Antenna

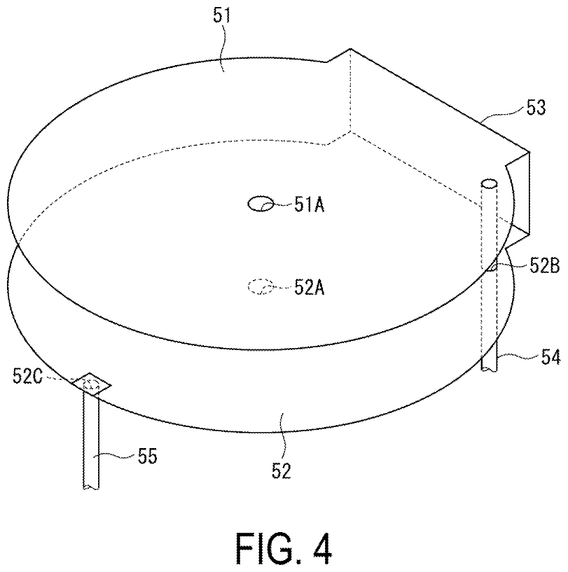

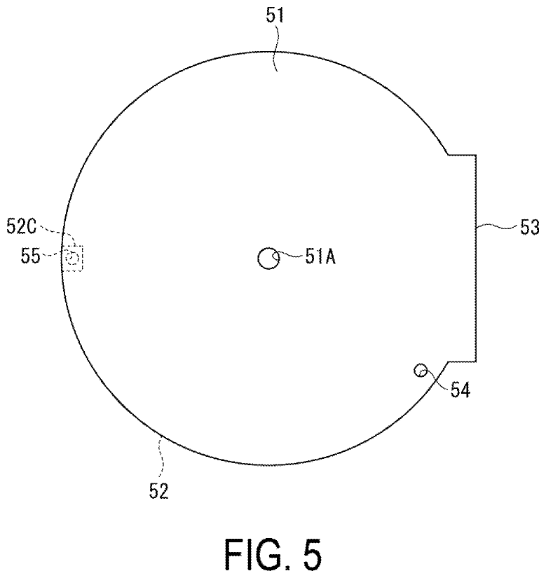

As illustrated in FIGS. 2, 4, and 5, the planer inverted-F antenna 50 includes the planer first conductor element 51, a planer second conductor element 52 disposed so as to overlap the first conductor element 51 in plan view, and a short-circuit element 53 that short-circuits the first conductor element 51 and the second conductor element 52.

The first conductor element 51 is electrically coupled to the reception IC 70 mounted on the printed circuit board 23 via a feed element 54. The second conductor element 52 is electrically coupled to a ground terminal of the printed circuit board 23 via a connection element 55.

The first conductor element 51 and the second conductor element 52 are formed in a disc shape smaller than the dial 2, and through holes 51A and 52A through which the pointer shafts 35 to 37 are inserted are formed in a planar center position. A through hole 52B through which the feed element 54 is inserted and a ground terminal 52C to which the connection element 55 is coupled are formed in the second conductor element 52.

As described above, the through hole 52B and the like are provided in the second conductor element 52, and the first conductor element 51 and the second conductor element 52 are not members that completely have the same shape and the same area. Therefore, overlapping of the first conductor element 51 and the second conductor element 52 in plan view also includes a case in which there is a portion having a part that does not overlap, such as the through hole 52B. In other words, the first conductor element 51 and the second conductor element 52 may be disposed so as to function as the planer inverted-F antenna 50. Note that, as the planer inverted-F antenna 50, the second conductor element 52 serving as a ground electrode may be formed in size greater than that of the first conductor element 51 serving as a radiation electrode, and a position of an outer periphery of the first conductor element 51 may be disposed inside an outer periphery of the second conductor element 52.

Furthermore, the first conductor element 51 and the second conductor element 52 may have a hole for avoiding another component and an irregular shape on the outer periphery for attachment. Even when a part of the first conductor element 51 and a part of the second conductor element 52 are configured not to overlap each other in plan view by adopting the structure, that is, as long as the first conductor element 51 and the second conductor element 52 as a whole overlap each other, the first conductor element 51 and the second conductor element 52 can be used as the planer inverted-F antenna 50 even without the parts overlapping each other.

Further, in the present exemplary embodiment, the first conductor element 51 is disposed on the front surface of the main plate 21, the second conductor element 52 is disposed on the back surface of the main plate 21, and the first conductor element 51 and the second conductor element 52 are disposed away from each other in a vertical direction by a thickness dimension of the main plate 21. Furthermore, in a distance H in the axial direction orthogonal to the front surface of the dial 2, the distance H between the first conductor element 51 and the hour hand 31 closest to the first conductor element 51 is set to be equal to or greater than 1.35 mm.

The first conductor element 51 and the second conductor element 52 may be formed of a metal thin plate such as copper, a copper alloy, aluminum, and an aluminum alloy, for example. The first conductor element 51 and the second conductor element 52 are made of metal in this way, and thus the first conductor element 51 and the second conductor element 52 can be reduced in thickness and can be easily molded. Further, the first conductor element 51 and the second conductor element 52 can be formed with a thin plate formed of a non-conductive material as a substrate and with a metal coating on a front surface of the substrate. The metal coating can be formed by plating of copper, silver, nickel, aluminum, and the like, for example.

Note that one of the first conductor element 51 and the second conductor element 52 may be made of metal, and the other may be formed by applying a metal coating to the substrate.

The short-circuit element 53 is formed of a material similar to that of the first conductor element 51 and the second conductor element 52, namely, a conductive material. The short-circuit element 53 is provided at an outer edge portion of the first conductor element 51 and the second conductor element 52.

The short-circuit element 53 may be formed linearly so as to vertically couple the first conductor element 51 and the second conductor element 52, or may be formed so as to include a curved portion protruding to the outer peripheral side. By providing the curved portion in the short-circuit element 53, the curved portion can function as a buffering portion that buffers an impact given from the outside.

Note that the short-circuit element 53 may be provided in one location or may be provided in a plurality of locations. In other words, the first conductor element 51, the second conductor element 52, and the short-circuit element 53 may be designed so as to be able to acquire a reception characteristic needed for receiving a GPS satellite signal.

The first conductor element 51, the second conductor element 52, and the short-circuit element 53 may be formed in an integral structure by using a method for bending and molding a metal thin plate by pressing, for example. The planer inverted-F antenna 50 can be more efficiently manufactured by applying such a configuration.

The feed element 54 is coupled to a feed terminal provided on the printed circuit board 23, and has a function of supplying a signal received by the first conductor element 51 and the second conductor element 52 to the reception IC 70 mounted on the printed circuit board 23.

The connection element 55 couples the ground terminal provided on the printed circuit board 23 and the ground terminal 52C provided on the second conductor element 52.

Note that, when a solar panel is provided between the dial 2 and the first conductor element 51, the first conductor element 51 may also serve as a support substrate of the solar panel.

Hand Movement Control

Next, hand movement control during the reception processing of a satellite signal in the electronic watch 1 will be described. The electronic watch 1 includes manual reception processing of receiving a satellite signal by pressing the button 7A by a user and automatic reception processing of automatically receiving a satellite signal at a preset time.

Further, the manual reception processing includes positioning reception processing of capturing three or more GPS satellites, receiving a satellite signal, acquiring time information, and further calculating positional information, and timekeeping reception processing of capturing one or more GPS satellite, receiving a satellite signal, and acquiring time information. The positioning reception processing and the timekeeping reception processing are selected depending on time during which the user keeps pressing the button 7A, for example. On the other hand, the automatic reception processing performs the timekeeping reception processing.

Timekeeping Reception Processing

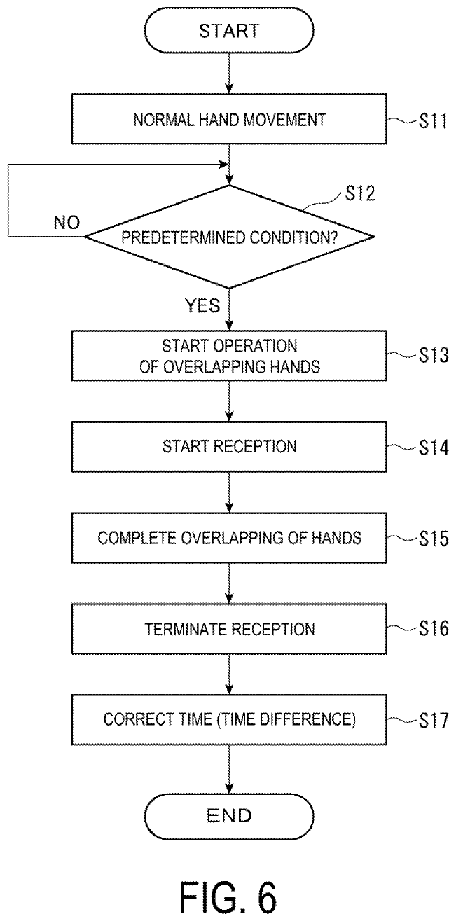

Control in the timekeeping reception processing will be described with reference to a flowchart in FIG. 6, and FIG. 1.

As illustrated in FIG. 6, the control IC 60 performs normal hand movement processing in step S11 of controlling the first motor 101, the second motor 102, and the third motor 103, and indicating a current time with the hour hand 31, the minute hand 32, and the seconds hand 33 under normal circumstances.

The control IC 60 performs step S12 during the normal hand movement processing, and determines whether or not a condition falls under a predetermined condition for performing the timekeeping reception processing. When the control IC 60 determines NO in step S12, the normal hand movement processing in step S11 continues until the control IC 60 determines YES in the determination processing in step S12.

When the condition falls under the predetermined condition in step S12, such as a case in which the user performs a timekeeping reception start operation or a case in which it is time for performing the automatic reception processing, and the control IC 60 determines YES in step S12, the control IC 60 performs step S13 of starting an operation of overlapping hands.

When performing step S13, the control IC 60 controls drive of the first motor 101, the second motor 102, and the third motor 103 so as to move the hour hand 31, the minute hand 32, and the seconds hand 33 to a reception standby position. In the present exemplary embodiment, the reception standby position during timekeeping reception is set to a position indicating a scale of a 12 o'clock position of the dial 2. Thus, for example, as illustrated in FIG. 1, when the hour hand 31, the minute hand 32, and the seconds hand 33 indicate 1:50:38 and the operation in step S13 starts, the control IC 60 moves the hour hand 31, the minute hand 32, and the seconds hand 33 to the 12 o'clock position and stops the hand movement in the position. Note that the 12 o'clock position being the reception standby position during the timekeeping reception is one example of a first position.

When the hour hand 31, the minute hand 32, and the seconds hand 33 indicate the same scale, directions of pointer axes being axis lines each connecting a rotary shaft of the pointer shafts 35 to 37 and a tip of the hour hand 31, the minute hand 32, and the seconds hand 33 coincide with each other. In this case, 60% or more of the planar area of the second conductive portion 320 of the minute hand 32 overlaps the first conductive portion 310 of the hour hand 31 in plan view. Further, 60% or more of the planar area of the third conductive portion 330 of the seconds hand 33 overlaps the second conductive portion 320 of the minute hand 32 in plan view.

Note that a hand movement of the hour hand 31, the minute hand 32, and the seconds hand 33 is independently controlled by the first motor 101, the second motor 102, and the third motor 103, and thus, in the example illustrated in FIG. 1, the minute hand 32 and the seconds hand 33 are moved clockwise to the 12 o'clock position, the hour hand 31 is moved counterclockwise to the 12 o'clock position, and it is controlled such that the amount of the hand movement to the reception standby position is minimized.

When starting the operation of moving the hour hand 31, the minute hand 32, and the seconds hand 33 to the reception standby position in step S13, the control IC 60 performs step S14 even in a case in which the movement to the received standby position is not completed, activates the reception IC 70, and starts the reception processing of a satellite signal.

When the hour hand 31, the minute hand 32, and the seconds hand 33 are moved to the reception standby position, which is a position indicating 00:00:00 or 12:00:00 in the present exemplary embodiment, the control IC 60 performs step S15, stops the hand movement of the hour hand 31, the minute hand 32, and the seconds hand 33, and completes the overlapping of hands.

Further, the control IC 60 performs step S16, and terminates the reception processing of a satellite signal. Note that the reception processing in step S16 is normally terminated when time information can be acquired, but the reception processing is also terminated when time information cannot be acquired, for example, when a GPS satellite cannot be captured and when it is determined that time information cannot be acquired due to a low satellite signal level.

Further, timing at which overlapping of hands in step S15 is completed, that is, at which the movement to the reception standby position is completed and timing at which reception is terminated in step S16 depend on a position of the hour hand 31, the minute hand 32, and the seconds hand 33 before the movement to the reception standby position and a reception environment of a satellite signal, and thus overlapping of hands may be completed after the reception is terminated in contrast to the flowchart in FIG. 6.

After the reception is terminated in step S16, the control IC 60 performs time correction processing in step S17, and moves the hour hand 31, the minute hand 32, and the seconds hand 33 to a position indicating a corrected time, and the normal hand movement is returned.

When acquisition of the time information is successful during the timekeeping reception, the reception IC 70 outputs Coordinate Universal Time (UTC) acquired by correcting the acquired GPS time by leap second information to the control IC 60. The control IC 60 calculates a local time by adding time difference information of a current position to Coordinate Universal Time received from the reception IC 70, and indicates the local time with the hour hand 31, the minute hand 32, and the seconds hand 33. The local time is updated by a time counter by using a reference signal acquired by dividing an oscillation signal of a crystal oscillator.

When acquisition of the time information fails during the timekeeping reception, the reception IC 70 indicates a current time acquired from the time counter that counts the current time with the hour hand 31, the minute hand 32, and the seconds hand 33.

Positioning Reception Processing

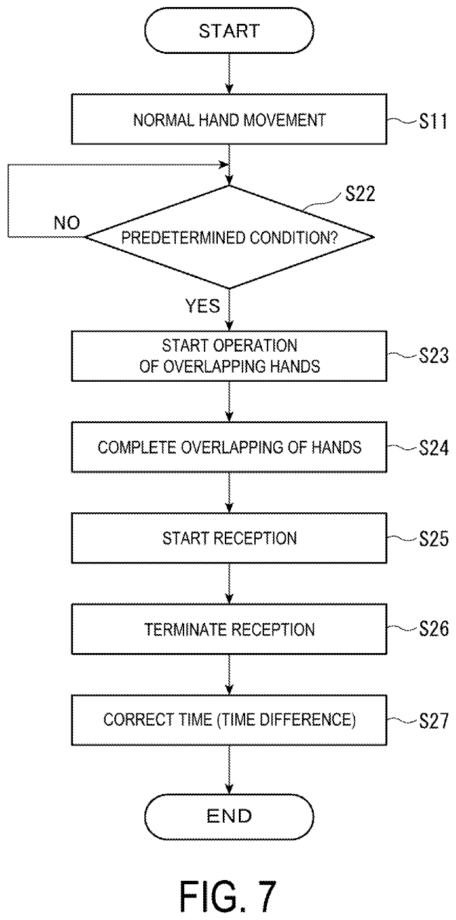

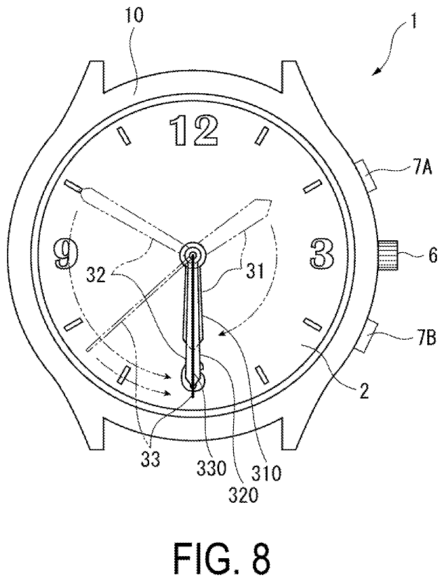

Next, control in the positioning reception processing will be described with reference to a flowchart in FIG. 7, and FIG. 8.

As illustrated in FIG. 7, the control IC 60 performs normal hand movement processing in step S11 of controlling the first motor 101, the second motor 102, and the third motor 103, and indicating a current time with the hour hand 31, the minute hand 32, and the seconds hand 33 under normal circumstances.

The control IC 60 performs step S22 during the normal hand movement processing, and determines whether or not a condition falls under a predetermined condition for performing the positioning reception processing. When the control IC 60 determines NO in step S22, the normal hand movement processing in step S11 continues until the control IC 60 determines YES in the determination processing in step S22.

In other words, the control IC 60 performs the determination processing in each of step S12 in FIG. 6 of determining whether a condition falls under the execution condition of the timekeeping reception processing and step S22 in FIG. 7 of determining whether a condition falls under the execution condition of the positioning reception processing during the normal hand movement processing in step S11. Then, when YES is determined in step S12, steps S13 to S17 in FIG. 6 are performed, and, when YES is determined in step S22, steps S23 to S27 in FIG. 7 are performed as described below.

When the user performs a positioning reception start operation, the condition falls under the predetermined condition in step S22, and thus the control IC 60 determines YES in step S22 and performs step S23 of starting an operation of overlapping hands. When performing step S23, the control IC 60 controls drive of the first motor 101, the second motor 102, and the third motor 103 so as to move the hour hand 31, the minute hand 32, and the seconds hand 33 to a reception standby position.

In the present exemplary embodiment, the reception standby position during the positioning reception processing is set to a position indicating a scale of a 6 o'clock position of the dial 2. In other words, in the present exemplary embodiment, the control IC 60 moves the hour hand 31, the minute hand 32, and the seconds hand 33 to the 12 o'clock position during the timekeeping reception processing, and moves the hour hand 31, the minute hand 32, and the seconds hand 33 to the 6 o'clock position during the positioning reception processing. Note that the 6 o'clock position being the reception standby position during the positioning reception is one example of a second position.

Thus, for example, as illustrated in FIG. 8, when the hour hand 31, the minute hand 32, and the seconds hand 33 indicate 1:50:38 and the operation in step S23 starts, the control IC 60 moves the hour hand 31, the minute hand 32, and the seconds hand 33 to the 6 o'clock position and stops the hand movement in the position. Note that a hand movement of the hour hand 31, the minute hand 32, and the seconds hand 33 is independently controlled by the first motor 101, the second motor 102, and the third motor 103, and thus, in the example illustrated in FIG. 8, the minute hand 32 and the seconds hand 33 are moved counterclockwise to the 6 o'clock position, the hour hand 31 is moved clockwise to the 6 o'clock position, and it is controlled such that the amount of the hand movement to the reception standby position is minimized.

When the operation of moving the hour hand 31, the minute hand 32, and the seconds hand 33 to the reception standby position starts in step S23, and then the hour hand 31, the minute hand 32, and the seconds hand 33 are moved to the reception standby position, which is a position indicating 6:30:30 or 18:30:30 in the present exemplary embodiment, the control IC 60 performs step S24, stops the hand movement of the hour hand 31, the minute hand 32, and the seconds hand 33, and completes the overlapping of hands.

Next, the control IC 60 performs step S25, activates the reception IC 70, and starts the reception processing of a satellite signal.

Subsequently, the control IC 60 performs step S26, and terminates the reception processing of a satellite signal.

Note that the reception processing in step S26 is normally terminated when positional information can be calculated, but the reception processing is also terminated when positional information cannot be acquired, for example, when three or more GPS satellites cannot be captured and when it is determined that positional information cannot be calculated due to a low satellite signal level.

After the reception is terminated in step S26, the control IC 60 performs time correction processing in step S27, and moves the hour hand 31, the minute hand 32, and the seconds hand 33 to a position indicating a corrected time, and the normal hand movement is returned.

When the time information can be acquired in the positioning reception processing, the reception IC 70 outputs Coordinate Universal Time (UTC) acquired by correcting the acquired GPS time by leap second information to the control IC 60. The control IC 60 obtains, from a storage unit provided in the electronic watch 1, time difference information based on a current position acquired in the positioning reception processing at Coordinate Universal Time received from the reception IC 70, calculates a local time, and indicates the local time with the hour hand 31, the minute hand 32, and the seconds hand 33.

When acquisition of the time information fails during the timekeeping reception, the reception IC 70 acquires a current time from a time counter that counts the current time, and indicates the current time with the hour hand 31, the minute hand 32, and the seconds hand 33.

Advantageous Effects of First Exemplary Embodiment

Since the electronic watch 1 moves the hour hand 31 being the first pointer, the minute hand 32 being the second pointer, and the seconds hand 33 to the reception standby position and keeps them on standby in a part of a period of the reception processing of a satellite signal, an area in which the hour hand 31, the minute hand 32, and the seconds hand 33 overlap the first conductor element 51 in plan view can be minimized. In other words, 60% or more of a planar area of the second conductive portion 320 of the minute hand 32 overlaps the first conductive portion 310 of the hour hand 31, and 60% or more of a planar area of the third conductive portion 330 of the seconds hand 33 overlaps the second conductive portion 320 of the minute hand 32, and thus an area of the conductive portions 310, 320, and 330 facing the first conductor element 51 can be minimized. When the pointer shafts 35 to 37 to which the respective pointers 31 to 33 are attached are formed of a conductive material such as metal, durability is increased further than that when the pointer shafts 35 to 37 are formed of a non-conductive material such as resin, which is thus preferable. On the other hand, when the pointer shafts 35 to 37 are conductive, a current flows through the pointer shafts 35 to 37 and the conductive portions 310, 320, and 330 of the respective pointers 31 to 33, and an influence of a parasitic capacitor generated between the planer inverted-F antenna 50 and the conductive portions 310, 320, and 330 of the respective pointers 31 to 33 is increased. Then, a deviation of resonance frequency occurs, and there is a risk that the reception sensitivity may also decrease. According to the present exemplary embodiment, the area of the conductive portions 310, 320, and 330 facing the first conductor element 51 can be minimized, and thus a parasitic capacitor generated between the respective conductive portions 310, 320, and 330 of the hour hand 31, the minute hand 32, and the seconds hand 33 and the first conductor element 51 can also be limited to minimum. A deviation of the resonance frequency in the planer inverted-F antenna 50 due to an influence of the parasitic capacitor is then reduced, and a decrease in the reception sensitivity can also be suppressed to minimum.

In the present exemplary embodiment, Table 1 shows a result of measuring an improvement in antenna gain when a planar area of the first conductive portion 310 is 13 mm², a planar area of the second conductive portion 320 is 12 mm², and a planar area of the third conductive portion 330 is 4 mm². In Table 1, when the hour hand 31, the minute hand 32, and the seconds hand 33 are disposed at 15:00:30, that is, the pointer axes of the respective pointers 31 to 33 are disposed at an angle of 90 degrees with respect to each other, a portion where the conductive portions 310, 320, and 330 overlap each other in plan view is only a base portion fixed to the respective pointer shafts 35 to 37, and an area where the pointers overlap each other in plan view is minimum, a proportion of the area where the pointers overlap each other in plan view is 0%. Further, when, as in the reception standby position in the present exemplary embodiment, the pointers 31 to 33 indicate the same scale such as 12 o'clock and 6 o'clock, and an area where the conductive portions 310, 320, and 330 overlap each other in plan view is maximum, a proportion of the area is 100%. An antenna gain is improved by approximately 3 dB at maximum when the proportion of the area where the pointers overlap each other in plan view is 100% as compared to a case in which the proportion is 0%. Therefore, a probability of successfully receiving a satellite signal can also be improved.

Further, as shown in Table 1, a proportion of improvement in the antenna gain increases around when the proportion of the area where the conductive portions of the respective pointers overlap each other is 60%. Thus, 60% or more of the planar area of the second conductive portion 320 of the minute hand 32 may overlap the first conductive portion 310 of the hour hand 31, and 60% or more of the planar area of the third conductive portion 330 of the seconds hand 33 may overlap the second conductive portion 320 of the minute hand 32.

TABLE 1

| | AREA RATIO [%] IN WHICH CONDUCTIVE | | | | | |
|---|---|---|---|---|---|---|
| | PORTION OF MINUTE HAND/SECONDS | | | | | |
| | HAND OVERLAPS CONDUCTIVE PORTION | | | | | |
| | OF HOUR HAND/MINUTE HAND | | | | | |
| | 0 | 20 | 40 | 60 | 80 | 100 |
| IMPROVED | 0 | 0 | 0.2 | 1 | 2.5 | 3 |
| ANTENNA | | | | | | |
| GAIN [dB] | | | | | | |

Since the electronic watch 1 moves each of the pointers 31 to 33 to the 12 o'clock position during the timekeeping reception processing and moves each of the pointers 31 to 33 to the 6 o'clock position during the positioning reception processing, the user can easily determine whether current reception processing is the timekeeping reception processing or the positioning reception processing. Thus, even when a wrong selection operation between the timekeeping reception processing and the positioning reception processing by the button 7A is performed, the operation can be immediately checked and start over.

As illustrated in FIG. 6, the control IC 60 starts reception before each of the pointers 31 to 33 finishes moving to the reception standby position during the timekeeping reception processing, and thus the time until the reception is terminated can be shortened.

As illustrated in FIG. 7, the control IC 60 starts reception after each of the pointers 31 to 33 moves to the reception standby position during the positioning reception processing, and thus an influence of the parasitic capacitor from the start of the reception can be minimized, and a decrease in the reception sensitivity can be suppressed to minimum.

In other words, a satellite signal may be able to be received from at least one GPS satellite in the timekeeping reception processing, and there is a high possibility that a satellite signal at a high signal level can be received, and thus a probability of successful reception is high even when the reception starts before each of the pointers 31 to 33 finishes moving to the reception standby position. On the other hand, a satellite signal needs to be received from three or more GPS satellites in the positioning reception processing, and thus there is a possibility that a satellite signal at a low signal level may be included. For this reason, a possibility of successful reception can be increased by starting the reception after each of the pointers 31 to 33 finishes moving to the reception standby position.

Since a total value of the planar areas of the conductive portions of the respective pointers 31 to 33 is less than 50 mm² in the electronic watch 1, an antenna gain can be improved further than that when the total value is equal to or greater than 50 mm².

For example, in the electronic watch 1 according to the first exemplary embodiment, an antenna gain is improved by approximately 3 dB at maximum in a reception experiment result when a total value of the planar areas of the conductive portions is 29 mm² and the pointers 31 to 33 move to a 00:00:00 position as compared to a reception experiment result when a planar area of the seconds hand 33 is 6 mm², a planar area of the minute hand 32 is 23 mm², and a planar area of the hour hand 31 is 21 mm², that is, a total value of the planar areas of the conductive portions is 50 mm² and the pointers 31 to 33 move to the 00:00:00 position. In other words, as an area where the pointers 31 to 33 overlap the first conductor element 51 in plan view is smaller when the pointers 31 to 33 overlap each other in plan view, a parasitic capacitor can be reduced, a deviation of a resonance frequency can be reduced, an antenna gain can be improved, and reception sensitivity can be improved.

Since the distance H between the hour hand 31 being the first pointer and the first conductor element 51 in the axial direction orthogonal to the front surface of the dial 2 is equal to or greater than 1.35 mm in the electronic watch 1, an antenna gain can be improved further than that when the distance H is less than 1.35 mm.

In other words, when each of the pointers 31 to 33 is moved to the 00:00:00 position in the electronic watch 1 according to the first exemplary embodiment, an antenna gain is improved by approximately 3 dB at maximum in a reception experiment result in which the distance H between the hour hand 31 and the first conductor element 51 is 1.35 mm as compared to a reception experiment result in which the distance H is 1.30 mm. In other words, as the distance between the hour hand 31 closest to the first conductor element 51 and the first conductor element 51 is increased, the parasitic capacitor decreases, a deviation of the resonance frequency is reduced, the antenna gain can be improved, and the reception sensitivity can be improved.

### Second Exemplary Embodiment

An electronic watch 1B according to a second exemplary embodiment will be described with reference to the drawings. Note that, in the following description, the electronic watch 1B will be described simply as an electronic watch 1B. Further, the same or similar components as or to those of the electronic watch 1 in the first exemplary embodiment will be given the same reference numerals and detailed description will be omitted or simplified.

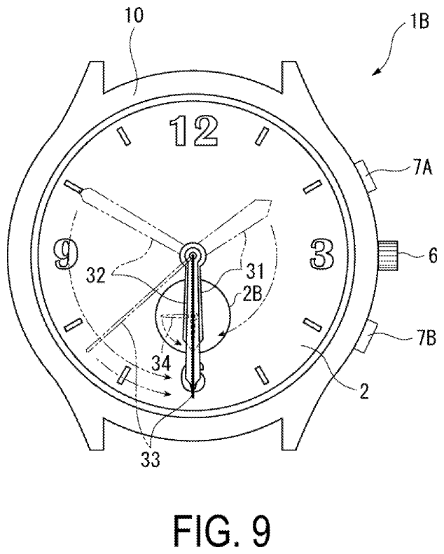

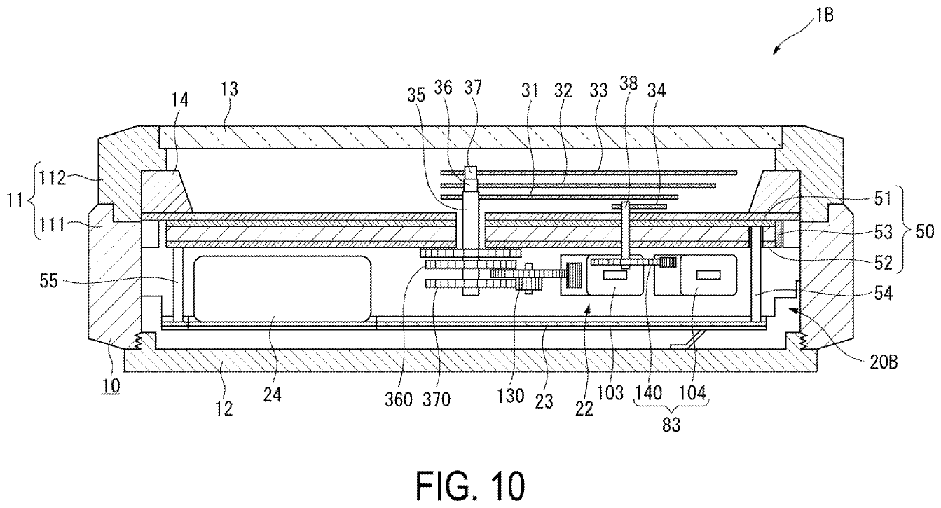

As illustrated in FIGS. 9 and 10, the electronic watch 1B is different from the electronic watch 1 in that the electronic watch 1B includes a small hand 34 and a third drive unit 83 that drives the small hand 34 in the dial 2, and the other components are the same as those of the electronic watch 1.

A sub-dial 2B is provided on the 6 o'clock side with respect to the planar center of the dial 2 in the dial 2, and a pointer shaft 38 of the small hand 34 is disposed in a planar center position of the sub-dial 2B. Further, a fourth motor 104 and a fourth train wheel 140 are provided, in a movement 20B, as the third drive unit 83 that drives the small hand 34 and the pointer shaft 38. The small hand 34 and the pointer shaft 38 are formed of a conductive material.

In the electronic watch 1B according to the second exemplary embodiment, in both of the positioning reception processing and the timekeeping reception processing, the hour hand 31, the minute hand 32, and the seconds hand 33 are moved to a position indicating a scale of 6 o'clock, namely, the reception standby position. Further, the third drive unit 83 moves the small hand 34 to a position overlapping the hour hand 31 and the minute hand 32, that is, to a position indicating the 6 o'clock side or the 12 o'clock side in the sub-dial 2B.

In this way, all of the pointers 31 to 34 overlap each other in plan view during the reception processing, and an area of the pointers 31 to 34 overlapping the first conductor element 51 in plan view can be minimized. Therefore, the electronic watch 1B can also achieve advantageous effects similar to those of the electronic watch 1 according to the first exemplary embodiment described above, such as advantageous effects capable of reducing a parasitic capacitor, reducing a deviation of a resonance frequency, improving an antenna gain, and improving reception sensitivity.

### Third Exemplary Embodiment

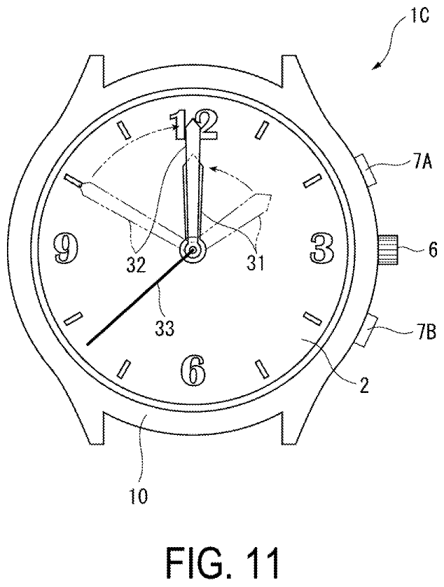

As illustrated in FIG. 11, an electronic watch 1C according to a third exemplary embodiment is different from the electronic watch 1 according to the first exemplary embodiment described above in that the hour hand 31 and the minute hand 32 are moved to the 12 o'clock position and the 6 o'clock position and overlap each other in plan view, and the seconds hand 33 stops in a current indicated position or a hand movement thereof continues in both of the positioning reception processing and the timekeeping reception processing.

Since the minute hand 32 and the hour hand 31 are moved to a position in which they overlap each other in plan view during the reception processing, such an electronic watch 1C can also achieve advantageous effects similar to those of the electronic watch 1 according to the first exemplary embodiment described above, such as advantageous effects capable of reducing a parasitic capacitor, reducing a deviation of a resonance frequency, improving an antenna gain, and improving reception sensitivity.

Further, since the seconds hand 33 has a smaller planar area than that of the hour hand 31 and the minute hand 32 and has a greater distance from the first conductor element 51, a parasitic capacitor being generated is also smaller and an influence on an antenna gain is also smaller than those of the hour hand 31 and the minute hand 32. Therefore, during the reception period, even when the seconds hand 33 does not overlap the hour hand 31 and the minute hand 32 in plan view, a deviation of the resonance frequency is reduced, the antenna gain can be improved, and the reception sensitivity can be improved. For example, the antenna gain can be improved by approximately 2 dB at maximum and the reception sensitivity can be improved in a reception experiment result when the hour hand 31, the minute hand 32, and the seconds hand 33 are located in a 00:00:20 position, that is, when the hour hand 31 and the minute hand 32 overlap each other in plan view without the seconds hand 33 overlapping as compared to a reception experiment result when the hour hand 31, the minute hand 32, and the seconds hand 33 are located in a 15:00:30 position, that is, when the pointer axes of the respective pointers 31 to 33 are oriented in a direction in which they intersect each other at 90 degrees.

Note that, when two pointers of the hour hand 31, the minute hand 32, and the seconds hand 33 overlap each other in plan view, overlapping of the minute hand 32 and the hour hand 31 have the highest effect as in the electronic watch 1C according to the third exemplary embodiment, but another combination of the pointers may be used. In other words, the hour hand 31 and the seconds hand 33 may overlap each other in plan view, and the minute hand 32 and the seconds hand 33 may overlap each other in plan view. When the reception processing is performed while any two pointers of the hour hand 31, the minute hand 32, and the seconds hand 33 overlap each other in plan view, the reception sensitivity can be improved further than that when the reception processing is performed while the three pointers 31 to 33 do not overlap each other in plan view.

### Fourth Exemplary Embodiment

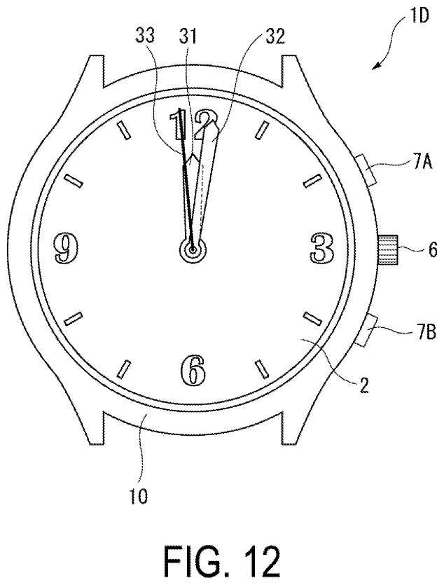

As illustrated in FIG. 12, an electronic watch 1D according to a fourth exemplary embodiment is configured such that a part of the minute hand 32 and a part of the seconds hand 33 overlap the hour hand 31 in plan view during the reception processing. In other words, it is set in each of the exemplary embodiments described above such that the pointer axes of the minute hand 32 and the seconds hand 33 coincide with the pointer axis of the hour hand 31, and an area where the hour hand 31, the minute hand 32, and the seconds hand 33 overlap the first conductor element 51 in plan view is minimum.

On the other hand, in the electronic watch 1D, the pointer axes of the minute hand 32 and the seconds hand 33 are disposed so as to be offset with respect to the pointer axis of the hour hand 31. Also, in this case, an area where the second conductive portion 320 of the minute hand 32 being the second pointer overlaps the first conductive portion 310 of the hour hand 31 being the first pointer in plan view is set to 60% or more of the planar area of the second conductive portion 320. Note that, in the present exemplary embodiment, an area where the third conductive portion 330 of the seconds hand 33 overlaps the first conductive portion 310 in plan view is also set to 60% or more of the planar area of the third conductive portion 330.

Since the minute hand 32 and the seconds hand 33 are moved to a position overlapping the hour hand 31 in plan view during the reception processing, such an electronic watch 1D can also achieve advantageous effects similar to those of the electronic watch 1 according to the first exemplary embodiment described above, such as advantageous effects capable of reducing a parasitic capacitor, reducing a deviation of a resonance frequency, improving an antenna gain, and improving reception sensitivity.

In other words, when the inventor performs a reception processing experiment while changing an area where the minute hand 32 overlaps the hour hand 31, there is almost no influence on reception as long as 60% or more of the planar area of the minute hand 32 overlaps the hour hand 31, whereas the influence on the reception increases as the overlapping area is reduced in a case of less than 60%. Therefore, by setting such that 60% or more of the planar area of the minute hand 32, that is, 60% or more of the planar area of the conductive portion of the minute hand 32 overlaps the hour hand 31 in plan view, an influence of a parasitic capacitor can be reduced, and an influence on the reception of a satellite signal can also be reduced.

Further, since each of the pointers 31 to 33 does not need to be moved to a position in which the pointer axes of the hour hand 31, the minute hand 32, and the seconds hand 33 coincide with each other during the reception processing, the time until the movement of the pointers 31 to 33 is completed can be shortened.

### Fifth Exemplary Embodiment

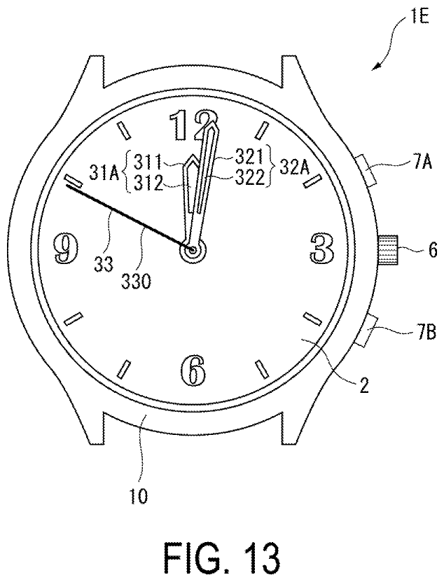

As illustrated in FIG. 13, an electronic watch 1E according to a fifth exemplary embodiment includes an hour hand 31A formed of a first conductive portion 311 having an opening and luminous paint 312 formed of a non-conductive member such as a ceramic fitted into the opening, and a minute hand 32A formed of a second conductive portion 321 having an opening and luminous paint 322 formed of a non-conductive member such as a ceramic fitted into the opening. The entire seconds hand 33 is the third conductive portion 330 in the same manner as in each of the exemplary embodiments described above.

Also, in the electronic watch 1E, during the reception processing, each of the hour hand 31A, the minute hand 32A, and the seconds hand 33 may be moved to a position in which the pointer axes coincide with each other, or may be moved to a position in which the pointer axes of the hour hand 31A and the minute hands 32A are offset as illustrated in FIG. 13. Further, also, in the electronic watch 1E, 60% or more of the planar area of the second conductive portion 321 of the minute hand 32A may overlap the first conductive portion 311 of the hour hand 31A in plan view, but less than 60% may also be set.

In other words, by providing the luminous paint 312 and 322, an area of the first conductive portion 311 and the second conductive portion 321 of the hour hand 31A and the minute hand 32A is smaller than that of the first conductive portion 310 and the second conductive portion 320 of the pointer 31 and the minute hand 32 without the luminous paint 312 and 322. Therefore, even when an area where the second conductive portion 321 of the minute hand 32A overlaps the first conductive portion 311 of the hour hand 31A in plan view is less than 60% of the planar area of the second conductive portion 321, the area of the first conductive portion 311 and the second conductive portion 321 overlapping the first conductor element 51 in plan view is small, and thus necessary reception sensitivity can be maintained.

The electronic watch 1E can achieve advantageous effects similar to those in each of the exemplary embodiments described above. Furthermore, since the area of the first conductive portion 311 and the second conductive portion 321 is small, the reception sensitivity can be maintained even when the area where the second conductive portion 321 overlaps the first conductive portion 311 in plan view is small. Thus, a movement amount of the hour hand 31A and the minute hand 32A to the reception standby position can be smaller than that in the electronic watch 1D, and the time until the movement of the pointers 31 to 33 is completed can be shortened.

Note that, in the electronic watch 1E illustrated in FIG. 13, the seconds hand 33 does not overlap the hour hand 31A and the minute hand 32A, but the seconds hand 33 may also overlap the hour hand 31A or the minute hand 32A similarly to the electronic watch 1C according to the third embodiment.

Note that the present disclosure is not limited to the exemplary embodiments described above, and various modifications can be made within the scope of the gist of the present disclosure.

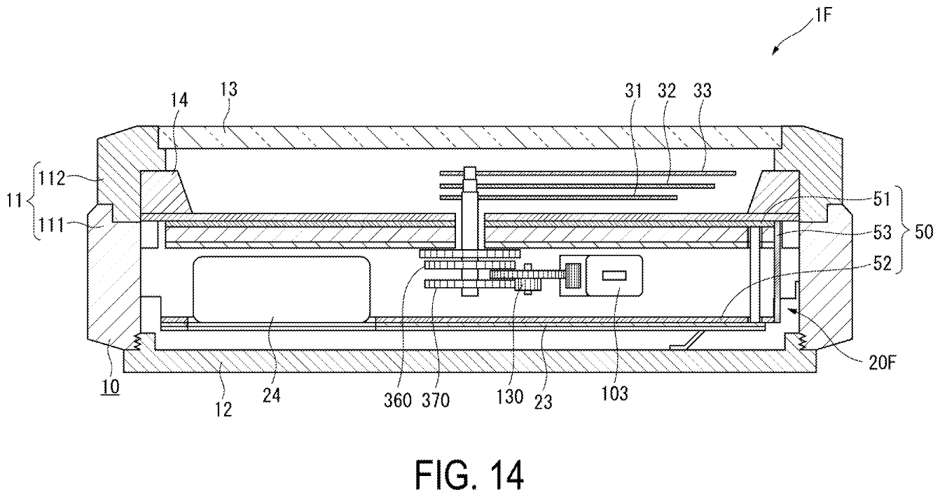

The configuration of the planer inverted-F antenna 50 is not limited to each of the exemplary embodiments described above. For example, as in a movement 20F of an electronic watch 1F illustrated in FIG. 14, the second conductor element 52 may be disposed on the top surface of the printed circuit board 23 instead of the lower surface of the main plate 21, and the first conductor element 51 and the second conductor element 52 may be disposed away from each other. In this case, the second conductor element 52 can be directly electrically coupled to the ground terminal of the printed circuit board 23, and the connection element 55 can be eliminated.

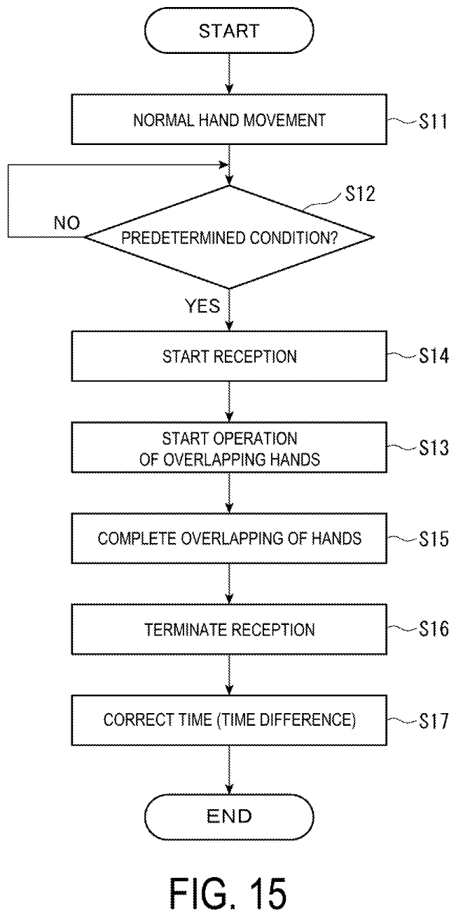

Further, in the first exemplary embodiment described above, as illustrated in the flowchart in FIG. 6 during the timekeeping reception processing, the operation of overlapping the hands in step S13 starts, and then the reception processing in step S14 starts. However, as illustrated in the flowchart in FIG. 15, the order of step S13 and step S14 may be switched, and the operation of overlapping the hands in step S13 may start after the start of the reception processing in step S14. Furthermore, the processing may be performed according to the flowchart in FIG. 7 during the timekeeping reception processing, or the processing may be performed according to the flowchart in FIG. 6 or FIG. 15 during the positioning reception processing.

In each of the exemplary embodiments described above, the pointers 31 to 33 are moved to the reception standby position that is preset during the reception processing. However, when two or three pointers overlap each other in plan view during the reception processing, a position in which any one of the pointers is currently disposed may be the reception standby position, and the other pointers may be moved to a position overlapping the pointer in plan view. For example, when the hour hand 31 and the minute hand 32 are to overlap each other in plan view, the minute hand 32 may be moved to a position of the hour hand 31, and conversely, the hour hand 31 may be moved to a position of the minute hand 32.

Further, when the pointers overlapping each other in plan view are simultaneously moved by respective independent motors, a position in which a movement amount and a movement time are minimum may be set to the reception standby position. For example, when the reception processing starts while the hour hand 31 and the minute hand 32 indicate 6:00, a 3 o'clock position, namely, a position in which the hour hand 31 and the minute hand 32 are moved by an angle of 90 degrees may be set to the reception standby position. Further, when a movement amount, namely, a movement angle of one step of the motor is different between the hour hand 31 and the minute hand 32, a position in which the hour hand 31 and the minute hand 32 can be moved in approximately the same number of steps may be set to the reception standby position.

Furthermore, the hour hand 31 and the minute hand 32 may be driven in conjunction with each other by one motor. However, driving the hour hand 31 and the minute hand 32 by respective independent motors is more advantageous in that the time until the hour hand 31 and the minute hand 32 overlap each other in plan view can be shortened.

A time at which the automatic reception processing is executed may be set to a time at which at least the hour hand 31 and the minute hand 32 overlap each other in plan view. In this case, the hour hand 31 and the minute hand 32 already overlap each other in plan view during the automatic reception processing, and thus the reception processing can also start without moving the hour hand 31 and the minute hand 32.

Further, the movement of the hour hand 31, the minute hand 32, and the seconds hand 33 may be set only during the manual reception processing, and the normal hand movement may continue during the automatic reception processing. The reason is that, since the timekeeping reception is performed during the automatic reception, an influence of the pointers 31 to 33 is smaller than that in the positioning reception, and there is a high possibility of successful reception even without the pointers overlapping each other in plan view. Further, the reason is that the user is less likely to visually recognize the electronic watch during the automatic reception, and an advantage of displaying that the automatic reception is being performed by overlapping the pointers in plan view is also low.

In the electronic watch, a proportion of the area of the second conductive portion 320 overlapping the first conductive portion 310, a total value of the planar areas of the conductive portions 310, 320, and 330, and a distance between the first conductor element 51 and the hour hand 31 are not limited to those in the exemplary embodiments described above. For example, with the hour hand 31 having a smaller planar area of the conductive portion 310 than that in the exemplary embodiment described above, a distance to the first conductor element 51 can be set to less than 1.35 mm. Therefore, these conditions may be set in a reception experiment result and the like for implementation.

The pointer shafts 35 to 38 are not limited to being formed of a conductive material, and may be formed of a non-conductive material.

In each of the exemplary embodiments described above, a satellite signal transmitted from a GPS satellite is received, but a signal received by the planer inverted-F antenna 50 is not limited thereto. For example, a satellite signal including time information may be received from other global navigation satellite systems (GNSS) such as Galileo (EU), GLONASS (Russia), and BeiDou (China), a stationary satellite such as SBAS, a quasi-zenith satellite, and the like.

Further, the present disclosure is not limited to such a satellite signal, and, for example, other radio waves such as Bluetooth (registered trademark), Bluetooth Low Energy (BLE), Wi-Fi (registered trademark), Near Field Communication (NFC), and Low Power Wide Area (LPWA) may be received.

Further, in an antenna different from the planer inverted-F antenna 50, such as a planer patch antenna, when a parasitic capacitor is generated by a metal pointer overlapping the antenna during reception and reception sensitivity is affected, conductive portions of a plurality of pointers may overlap each other in a part of a period of the reception processing similarly to the present disclosure.

What is claimed is:

1. An electronic watch with internal antenna, comprising:
an outer case including a case body, a case back, and a cover member;
a dial disposed between the cover member and the case back in the outer case;
a first pointer including a first conductive portion formed of a conductive material, the first pointer being disposed between the dial and the cover member;
a second pointer including a second conductive portion formed of a conductive material, the second pointer being disposed farther away from the dial than the first pointer is and between the dial and the cover member;
an antenna including a first conductor element disposed between the dial and the case back, a second conductor element disposed farther away from the dial than the first conductor element is and between the dial and the case back and overlapping the first conductor element in plan view when seen along an axial direction orthogonal to a front surface, which faces the cover member, of the dial, and a short-circuit element short-circuiting the first conductor element and the second conductor element; and
a drive unit moving the first pointer or the second pointer such that the first conductive portion and the second conductive portion overlap each other in the plan view for a part of a period of reception processing in which the antenna is used.

2. The electronic watch with internal antenna according to claim 1, wherein the drive unit moves the first pointer or the second pointer to a position in which 60% or more of a planar area of the second conductive portion overlaps the first conductive portion in the plan view.

3. The electronic watch with internal antenna according to claim 1, comprising:
a third pointer including a third conductive portion formed of a conductive material, and disposed farther away from the dial than the second pointer is and between the dial and the cover member; and
a second drive unit moving the third pointer such that the third conductive portion overlaps the first conductive portion or the second conductive portion in the plan view for a part of a period of reception processing in which the antenna is used.

4. The electronic watch with internal antenna according to claim 3, wherein the second drive unit moves the third pointer to a position in which 60% or more of a planar area of the third conductive portion overlaps the first conductive portion or the second conductive portion in the plan view.

5. The electronic watch with internal antenna according to claim 1, wherein the reception processing is processing of receiving a satellite signal transmitted from a positional information satellite using the antenna, and acquiring time information included in the satellite signal.

6. The electronic watch with internal antenna according to claim 1, wherein the reception processing is processing of receiving a satellite signal transmitted from three or more positional information satellites using the antenna, and calculating positional information using the satellite signal.

7. The electronic watch with internal antenna according to claim 1, wherein a total value of planar areas of the conductive portions of the pointers provided in a position overlapping the first conductor element in the plan view is less than 50 mm².

8. The electronic watch with internal antenna according to claim 1, wherein a distance between the first pointer and the first conductor element in an axial direction orthogonal to a front surface of the dial is equal to or greater than 1.35 mm.

9. The electronic watch with internal antenna according to claim 1, wherein a pointer shaft to which the first pointer is attached and a pointer shaft to which the second pointer is attached are formed of a conductive material.

10. The electronic watch with internal antenna according to claim 3, wherein a pointer shaft to which the first pointer is attached, a pointer shaft to which the second pointer is attached, and a pointer shaft to which the third pointer is attached are formed of a conductive material.

11. The electronic watch with internal antenna according to claim 5, wherein the drive unit moves the first pointer and the second pointer to a predetermined first position.

12. The electronic watch with internal antenna according to claim 6, wherein the drive unit moves the first pointer and the second pointer to a predetermined second position.

13. The electronic watch with internal antenna according to claim 1, comprising an external operation member, wherein
the reception processing is manual reception processing performed based on an operation of the external operation member.

14. The electronic watch with internal antenna according to claim 13, wherein
the electronic watch with internal antenna is configured to perform automatic reception processing of receiving a satellite signal when a preset time arrives, and
when the automatic reception processing is performed, the drive unit does not perform processing of moving the first pointer or the second pointer such that the first conductive portion and the second conductive portion overlap each other in the plan view for a part of a period of the automatic reception processing.
